(19) United States
(12) Patent Application Publication
(10) Pub. No.: US 2026/0323765 A1
(43) Pub. Date: Oct. 15, 2026

(54) METHOD AND DEVICE FOR TRANSMITTING AND RECEIVING UPLINK CONTROL INFORMATION IN WIRELESS COMMUNICATION SYSTEM

(71) Applicant: LG ELECTRONICS INC., Seoul (KR)

(72) Inventors: Youngdae LEE, Seoul (KR); Suckchel YANG, Seoul (KR); Seonwook KIM, Seoul (KR); Sechang MYUNG, Seoul (KR)

(73) Assignee: LG ELECTRONICS INC., Seoul (KR)

(21) Appl. No.: 19/483,562

(22) PCT Filed: May 13, 2024
(86) PCT No.: PCT/KR2024/006431

§ 371 Date: Nov. 11, 2025

(30) Foreign Application Priority Data
May 12, 2023 (KR) 10-2023-0062028

(51) Int. Cl. H04W 76/28; H04L 5/00

(52) U.S. Cl. CPC H04W 76/28; H04L 5/0044; H04L 5/0055

(57) ABSTRACT

A method and a device for transmitting and receiving uplink control information in a wireless communication system are disclosed. A method performed by a terminal in a wireless communication system according to an embodiment of the present disclosure may comprise the steps of: receiving information related to deactivation and activation for cell-related DTX or DRX; receiving DCI including information requesting an HARQ-ACK codebook; configuring the HARQ-ACK codebook for at least one serving cell indicated on the basis of the DCI; and transmitting uplink control information including the HARQ-ACK codebook.

### CROSS-REFERENCE TO RELATED APPLICATIONS

This application is the National Stage filing under 35 U.S.C. 371 of International Application No. PCT/KR2024/006431, filed on May 13, 2024, which claims the benefit of earlier filing date and right of priority to Korean Application No. 10-2023-0062028, filed on May 12, 2023, the contents of which are all hereby incorporated by reference herein in their entireties

### TECHNICAL FIELD

The present disclosure relates to a wireless communication system, and more specifically, to a method and an apparatus for transmitting and receiving uplink control information in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

The technical object of the present disclosure is to provide a method and an apparatus for transmitting and receiving uplink control information in a wireless communication system.

The technical object of the present disclosure is to provide a method and an apparatus for transmitting and receiving HARQ-ACK information for downlink transmission in a wireless communication system to which network energy saving (NES) is applied.

The technical objects to be achieved by the present disclosure are not limited to the above-described technical objects, and other technical objects which are not described herein will be clearly understood by those skilled in the pertinent art from the following description.

A method performed by a user equipment (UE) in a wireless communication system according to an aspect of the present disclosure may comprise: receiving information related to inactive and active of cell-related Discontinuous Transmission (DTX) or Discontinuous Reception (DRX); receiving DCI including information requesting a hybrid automatic repeat request-acknowledgement (HARQ-ACK) codebook; constructing the HARQ-ACK codebook for at least one serving cell indicated based on the DCI; and transmitting uplink control information including the HARQ-ACK codebook. Herein, based on cell-related DTX or DRX being inactive for a specific serving cell among the at least one serving cell, the HARQ-ACK codebook may include HARQ-ACK information for a remaining serving cell excluding the specific serving cell.

A method performed by a base station in a wireless communication system according to an additional aspect of the present disclosure may comprise, the method comprising: transmitting information related to inactive and active of cell-related Discontinuous Transmission (DTX) or Discontinuous Reception (DRX); transmitting DCI including information requesting a hybrid automatic repeat request-acknowledgement (HARQ-ACK) codebook; and receiving uplink control information including a HARQ-ACK codebook constructed for at least one serving cell indicated based on the DCI. Herein, based on cell-related DTX or DRX being inactive for a specific serving cell among the at least one serving cell, the HARQ-ACK codebook includes HARQ-ACK information for a remaining serving cell excluding the specific serving cell.

According to the present disclosure, a method and an apparatus for transmitting and receiving uplink control information in a wireless communication system may be provided.

According to the present disclosure, a method and an apparatus for transmitting and receiving HARQ-ACK information for downlink transmission in a wireless communication system to which network energy saving (NES) is applied may be provided.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 is a diagram illustrating an example of an operation for transmitting uplink control information of a user equipment (UE) according to the present disclosure.

FIG. 8 is a diagram illustrating an example of an operation for supporting transmission of uplink control information of a UE by a base station according to the present disclosure.

FIG. 9 illustrates a Type-1 HARQ-ACK codebook construction applicable to the present disclosure.

FIG. 10 illustrates an NES-based PDSCH and related HARQ-ACK codebook construction and transmission procedure according to an embodiment of the present disclosure.

FIG. 11 illustrates a block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN (New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

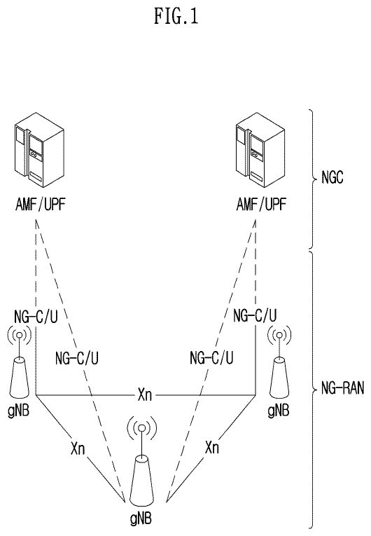

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

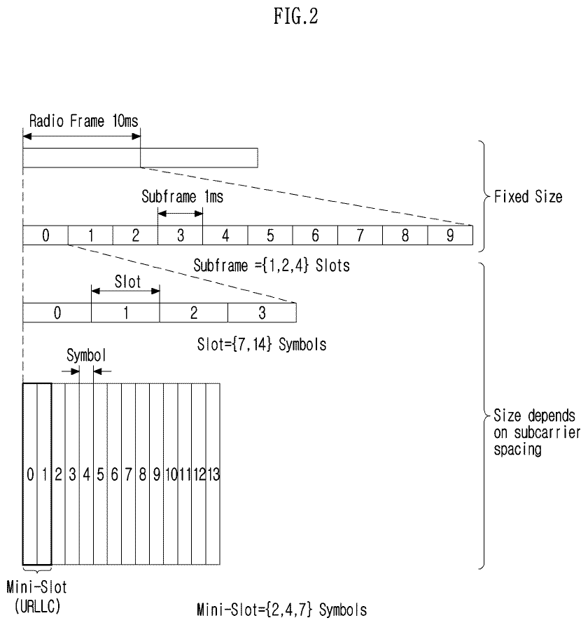

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, μ). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | | |
|---|---|---|---|
| designation | frequency range | Subcarrier Spacing | |
| FR1 | 410 MHz-7125 MHz | 15, 30, 60 | kHz |
| FR2 | 24250 MHz-52600 MHz | 60, 120, 240 | kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·10³ Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=Ims, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

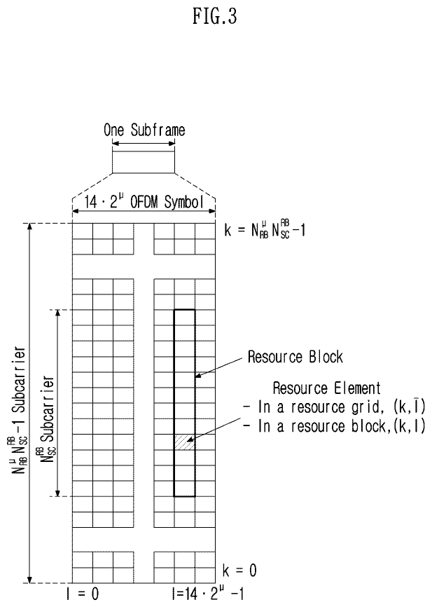

FIG. 2 is an example on μ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail. First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing. FIG. 3 illustrates a resource grid in a wireless communication system to which the present disclosure may be applied. In reference to FIG. 3, it is illustratively described that a resource grid is configured with N_{RB}^{μ}N_{sc}^{RB} subcarriers in a frequency domain and one subframe is configured with 14.24 OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}.The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, 1=0, . . . , N_{symb}^{μ}−1. A resource element (k,l′) for u and an antenna port p corresponds to a complex value, a_{k,l′}^{(p,μ)}. When there is no risk of confusion or when a specific antenna port or numerology is not specified, indexes p and u may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

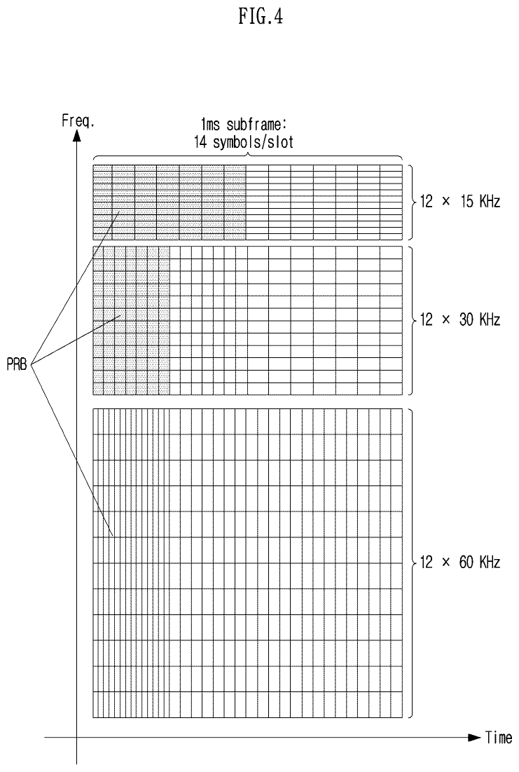

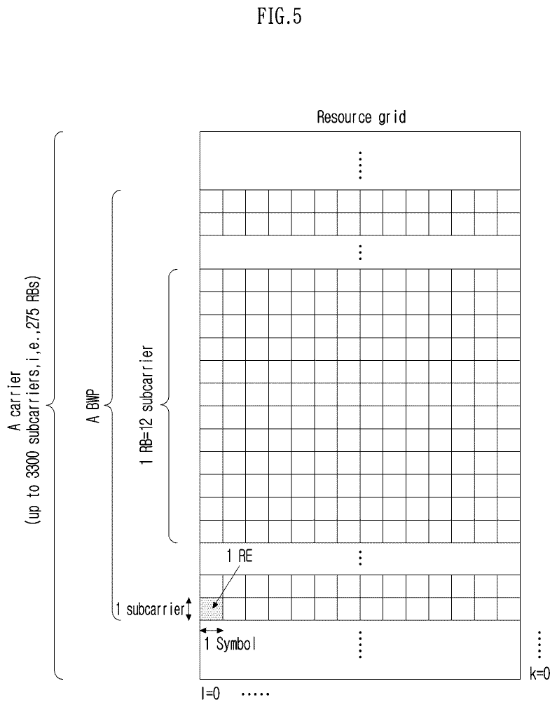

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

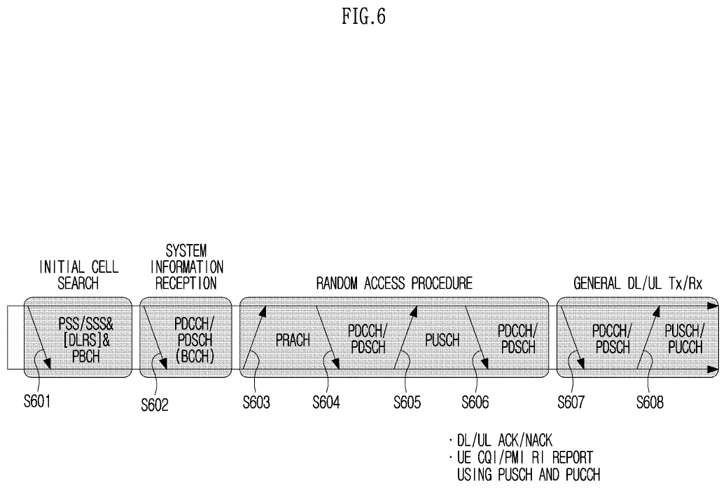

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted. DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted. DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Quasi-Co Location (QCL)

An antenna port is defined so that a channel where a symbol in an antenna port is transmitted can be inferred from a channel where other symbol in the same antenna port is transmitted. When a property of a channel where a symbol in one antenna port is carried may be inferred from a channel where a symbol in other antenna port is carried, it may be said that 2 antenna ports are in a QC/QCL (quasi co-located or quasi co-location) relationship.

Here, the channel property includes at least one of delay spread, doppler spread, frequency/doppler shift, average received power, received timing/average delay, or a spatial RX parameter. Here, a spatial Rx parameter means a spatial (Rx) channel property parameter such as an angle of arrival.

A terminal may be configured at list of up to M TCI-State configurations in a higher layer parameter PDSCH-Config to decode a PDSCH according to a detected PDCCH having intended DCI for a corresponding terminal and a given serving cell. The M depends on UE capability.

Each TCI-State includes a parameter for configuring a quasi co-location relationship between ports of one or two DL reference signals and a DM-RS of a PDSCH.

A quasi co-location relationship is configured by a higher layer parameter qcl-Type1 for a first DL RS and qcl-Type2 for a second DL RS (if configured). For two DL RSs, a QCL type is not the same regardless of whether a reference is a same DL RS or a different DL RS.

A quasi co-location type corresponding to each DL RS is given by a higher layer parameter qcl-Type of QCL-Info and may take one of the following values.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, it may be indicated/configured that a corresponding NZP CSI-RS antenna port(s) is quasi-colocated with a specific TRS with regard to QCL-Type A and is quasi-colocated with a specific SSB with regard to QCL-Type D. A terminal received such indication/configuration may receive a corresponding NZP CSI-RS by using a doppler, delay value measured in a QCL-TypeA TRS and apply a Rx beam used for receiving QCL-TypeD SSB to reception of a corresponding NZP CSI-RS.

UE may receive an activation command by MAC CE signaling used to map up to 8 TCI states to a codepoint of a DCI field ‘Transmission Configuration Indication’.

### Transmission and Reception of HARQ-ACK (Hybrid Automatic Repeat Request-Acknowledgement) Information Considering Network Energy Saving (NES)

The UE may support reception based on beamforming in downlink reception. That is, the UE may receive a downlink signal by using a specific beam among a plurality of candidate beams. When the UE is in a connected mode, the base station and the UE may maintain an optimal beam for the UE through a beam management (BM) procedure. Accordingly, the base station may transmit a downlink physical channel (e.g., PDCCH, PDSCH, etc.) by using an optimal transmission (TX) beam suitable for the UE, and the UE may receive the downlink physical channel by using an optimal reception (RX) beam.

For improvement of a wireless communication system, a scheme for reducing power consumption of a network node (for example, a base station, a cell, a TRP, a relay, etc.) is being discussed.

In this regard, in consideration of the Network Energy Saving (NES) operation of a network node, a PDSCH transmission and reception period during which a UE is unable to receive may occur, and there may arise a problem in that unnecessary HARQ-ACK information is included in a HARQ-ACK codebook.

In the present disclosure, various examples are provided to describe a method for configuring a HARQ-ACK codebook for a downlink channel (e.g., a PDSCH) depending on whether or not an NES operation is performed, when a UE connected to a base station performing the NES operation receives a transmission/retransmission for the downlink channel. In the following examples, the description mainly assumes the transmission and reception operation of the PDSCH and HARQ-ACK information thereof; however, the scope of the present disclosure is not limited thereto, and the examples of the present disclosure may similarly be applied to other downlink channels and HARQ-ACK information thereof

In the present disclosure, that the network node operates in an NES mode may mean performing the following operation. For example, the network node may set a plurality of periods (/sections) (i.e., discontinuous transmission (DTX) periods of the network node) for deactivating/OFF transmission of specific DL signal(s) during a predetermined specific time period in advance. The network node may dynamically indicate one OFF period among the configured plurality of OFF periods to the UE. The UE may know that the DL signal associated with the indicated OFF period will not be transmitted from the network node within the OFF period. Accordingly, power consumption of the network node and the UE may be saved.

In the NES mode, the OFF period may be defined in a time, frequency, and/or spatial domain. For example, the OFF period may be defined in the time domain, and time lengths of the plurality of OFF periods may be identical to each other or may be different from each other. For example, the OFF period may be defined in the frequency domain through a method such as bandwidth part (BWP) switching, dynamic RB adaptation, etc. For example, the OFF period may be defined in the spatial domain by deactivating specific antenna port(s) of the network node semi-statically or dynamically (i.e., the network node does not transmit/receive a wireless signal through the corresponding antenna port(s)).

For application of the operation according to the present disclosure, the network node may activate or deactivate the NES mode. For example, when one base station controls a plurality of cells, whether to activate the NES mode may be independently applied to each cell. In addition, the network node may inform the UE of information on activation or deactivation of NES.

Unless otherwise defined in the present disclosure, configuration for a UE by a base station may include providing the configuration information to the UE through higher layer (e.g., RRC) signaling. Unless otherwise defined in the present disclosure, command/indication of a base station to a UE may include providing the command/indication to the UE through MAC CE and/or DCI. Unless otherwise defined in the present disclosure, predefined information with respect to a base station and a UE may include information that the base station and the UE already possess in advance without separate signaling/command/indication.

In the present disclosure, with respect to an operation of a UE connected to a network node supporting an NES operation, different first period and second period may be configured/determined according to one or a plurality of the following cases.
Case 1. A first period operating in an NES mode and a second period operating in a non-NES mode
Case 2. A first period being an inactive time of cell DTX and a second period being an active time of cell DTX (that is, the first period corresponds to a time period in which the network node does not perform transmission (TX) for a specific cell, and the second period corresponds to a time period in which the network node performs transmission (TX) for a specific cell)
Case 3. A first period being an inactive time of UE DRX and a second period being an active time of UE DRX (that is, the first period corresponds to a time period in which the UE does not perform reception (RX), and the second period corresponds to a time period in which the UE performs reception (RX))
Case 4. A first period being an inactive time of cell DRX and a second period being an active time of cell DRX (that is, the first period corresponds to a time period in which the network node does not perform reception (RX), and the second period corresponds to a time period in which the network node performs reception (RX))
Case 5. A first period being an inactive time of UE DTX and a second period being an active time of UE DTX (that is, the first period corresponds to a time period in which the UE does not perform transmission (TX), and the second period corresponds to a time period in which the UE performs transmission (TX))

Based on configuration of the network node, only the second period may be set, or both the first period and the second period may be configured, for each of cell, BWP, frequency, RS for RLF (radio link failure) purpose, AP (antenna port), AP group, and/or antenna element group.

With respect to the aforementioned first period and second period, a time period other than the first period may correspond to the second period, and a time period other than the second period may correspond to the first period. Additionally, the network node may separately configured the first period and the second period for each of the aforementioned cases. In this case, for different cases, a specific time period may correspond to the first period or the second period. In consideration thereof, when a specific time period belongs only to the first period, the UE may perform the operation of the first period in the present disclosure, and when a specific time period belongs only to the second period, the UE may perform the operation of the second period in the present disclosure. Additionally or alternatively, when the first period and the second period overlap, the UE may perform only the operation of the first period in the present disclosure, or may preferentially perform the operation of the first period. Additionally or alternatively, when the first period and the second period overlap, the UE may perform only the operation of the second period in the present disclosure, or may preferentially perform the operation of the second period.

In the present disclosure, detailed examples are provided to describe a method for transmission and reception of a downlink channel and uplink feedback information therefor by a network node and a terminal, based on activation (e.g., corresponding to the above-described first period) and deactivation (for example, corresponding to the above-described second period) of cell DTX/DRX associated with NES.

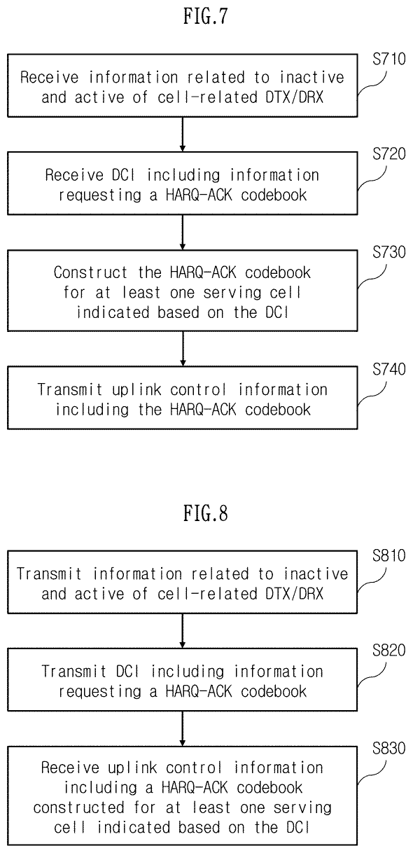

FIG. 7 is a diagram illustrating an example of an operation for transmitting uplink control information of a UE according to the present disclosure.

In step S710, the UE may receive, from the network, information related to deactivation and activation of cell-related Discontinuous Transmission (DTX) or Discontinuous Reception (DRX).

For example, the UE may be configured and/or indicated, through higher layer signaling and/or dynamic signaling, with information regarding a time period associated with network energy saving (NES) mode-based operation for one or more cells of the network, and with cell-related information. The UE may determine and/or define an active period and an inactive period for one or more cells based on the received information.

For example, the first information may be received through a Radio Resource Control (RRC) message or the like.

In step S720, the UE may receive Downlink Control Information (DCI) including information requesting a HARQ-ACK codebook.

For example, the HARQ-ACK codebook may be based on a HARQ-ACK codebook type that consists of HARQ-ACK information for the latest transport block (TB) per HARQ process, for at least one serving cell indicated by the DCI.

In step S730, the UE may configure the indicated HARQ-ACK codebook for at least one serving cell indicated based on the DCI.

For example, one or a plurality of serving cells may be configured for the UE, and in this case, at least one serving cell may be indicated through the DCI. In this regard, the activation/deactivation related to the above-described NES operation may be configured or indicated on a per-cell basis in units of a certain time period.

In this case, among the indicated serving cells, cell-related DTX/DRX may be deactivated for a specific serving cell. In such a case, the UE may configure a HARQ-ACK codebook including only HARQ-ACK information for the remaining serving cells other than the specific serving cell. Here, the HARQ-ACK information may be indicated as ACK or NACK. Additionally or alternatively, the UE may configure the HARQ-ACK codebook including HARQ-ACK information indicated as NACK for the specific serving cell. Additionally or alternatively, if there are no remaining serving cells, the UE may not construct the HARQ-ACK codebook. Additionally or alternatively, if cell-related DTX/DRX is deactivated for all of the indicated serving cells, the UE may not construct the HARQ-ACK.

In step S740, the UE may transmit uplink control information including the constructed codebook. For example, the HARQ-ACK codebook may be transmitted through a PUCCH resource or a PUSCH resource configured or indicated for transmission of the HARQ-ACK codebook.

In this regard, when the PUCCH resource through which the uplink control information is to be transmitted belongs to an inactive period in which the cell-related DTX/DRX is deactivated, transmission of the HARQ-ACK codebook may be deferred.

For example, when transmission of the HARQ-ACK codebook is deferred, the HARQ-ACK information included in the HARQ-ACK codebook may be constructed as a separate HARQ-ACK sub-codebook in an alternative PUCCH resource belonging to an active period in which the cell-related DTX/DRX is activated. In this case, when a new HARQ-ACK sub-codebook exists in relation to the alternative PUCCH resource (i.e., when new HARQ-ACK information is configured or indicated to be transmitted in the corresponding PUCCH resource), the HARQ-ACK codebook to be transmitted in the alternative PUCCH resource may be constructed based on the priority between the separate HARQ-ACK sub-codebook and the new HARQ-ACK sub-codebook. For example, when the priority between the separate HARQ-ACK sub-codebook and the new HARQ-ACK sub-codebook is the same, the HARQ-ACK codebook to be transmitted in the alternative PUCCH resource may be constructed by concatenating the separate HARQ-ACK sub-codebook with the new HARQ-ACK sub-codebook. As another example, when the priority between the separate HARQ-ACK sub-codebook and the new HARQ-ACK sub-codebook is different, the HARQ-ACK codebook to be transmitted in the alternative PUCCH resource may be constructed with only the HARQ-ACK sub-codebook having a higher priority.

Additionally or alternatively, in relation to the deferral of transmission of the HARQ-ACK codebook as described above, through certain signaling (e.g., higher layer signaling such as DCI or RRC), the UE may receive, from the base station, information regarding a maximum time duration by which transmission of the HARQ-ACK codebook may be deferred.

FIG. 8 is a diagram illustrating an example of an operation for supporting transmission of uplink control information of a UE by a base station according to the present disclosure.

In step S810, the base station may transmit, to the UE, information related to deactivation and activation of cell-related Discontinuous Transmission (DTX) or

### Discontinuous Reception (DRX).

Since the detailed characteristics regarding the deactivation and activation of the cell-related DTX/DRX are the same as those described with reference to FIG. 7, a redundant description thereof will be omitted.

In step S820, the base station may transmit Downlink Control Information (DCI) including information requesting a HARQ-ACK codebook.

Since the detailed characteristics regarding the type of the HARQ-ACK codebook and the DCI are the same as those described with reference to FIG. 7, a redundant description thereof will be omitted.

In step S830, the base station may receive, from the UE, uplink control information including a HARQ-ACK codebook constructed for at least one serving cell indicated based on the DCI.

Since the detailed characteristics regarding the construction of the HARQ-ACK codebook are the same as those described with reference to FIG. 7, a redundant description thereof will be omitted.

Hereinafter, various examples of NES-based PDSCH and construction and transmission/reception of a HARQ-ACK codebook therefor according to the present disclosure will be described.

### Embodiment 1

The present embodiment relates to a method for constructing and transmitting/receiving a Type-3 HARQ-ACK codebook based on a time period associated with NES.

For the UE in the present disclosure, a Type-3 HARQ-ACK codebook may be additionally configured together with other types of HARQ-ACK codebooks (e.g., a Type-1 HARQ-ACK codebook or a Type-2 HARQ-ACK codebook).

In this regard, the base station may allocate a PUCCH resource through DCI for scheduling a PDSCH or through non-scheduling DCI (e.g., DCI in which an FDRA field is invalid, or DCI for activating/releasing SPS). When the Type-3 HARQ-ACK codebook is constructed for the UE, the DCI scheduling or non-scheduling the PDSCH may indicate the Type-3 HARQ-ACK codebook to the UE. The UE having received the DCI indicating the Type-3 HARQ-ACK codebook may construct and transmit the Type-3 HARQ-ACK codebook for all or requested HARQ processes with respect to all or requested serving cell(s) indicated or configured.

Here, the Type-3 HARQ-ACK codebook may be constructed to include HARQ-ACK information (e.g., ACK or NACK) for the most recently received transport block (TB) of each HARQ process. Additionally, based on a request by the DCI, the Type-3 HARQ-ACK codebook may be constructed to further include a most recently received new data indicator (NDI) value for each HARQ process.

The UE constructs the Type-3 HARQ-ACK codebook as described above, and may transmit the Type-3 HARQ-ACK codebook to the base station through the PUCCH resource allocated by the base station.

One or a plurality of serving cells may be configured for the UE. Additionally, one or more of the configured serving cells may be in an activated state. In this regard, when a first period (i.e., a cell DTX/DRX inactive period) and a second period (i.e., a cell DTX/DRX active period) associated with NES operation are configured, if a specific serving cell is configured/activated, the UE may be configured to receive only a PDSCH including DL slots/symbols corresponding to the second period for the serving cell. Additionally or alternatively, in this case, the UE may be configured to receive only a PDSCH not including DL slots/symbols corresponding to the first period (i.e., a PDSCH not overlapping with the first period). Additionally or alternatively, in this case, the UE may be configured to receive only a PDSCH in which all DL slots/symbols constituting the PDSCH are included within the second period (i.e., a PDSCH fully included in the second period).

Here, the PDSCH may correspond to a PDSCH dynamically scheduled through DCI, an SPS PDSCH periodically allocated, or a PDSCH retransmitting a transport block (TB) of an SPS PDSCH.

In relation to the first period and the second period for the NES operation as described above, a part or all of PDSCH reception opportunities (i.e., K1 slots) configured or indicated by the base station through certain signaling (e.g., an RRC message, a MAC CE, or DCI) may be included in the first period. Alternatively, all or a part of the corresponding PDSCH reception opportunities may not be included in the second period. Hereinafter, in the present disclosure, such a case is referred to and determined as a state in which the corresponding PDSCH reception opportunity corresponds to an NES-off state.

In this regard, for all serving cells configured through higher layer signaling (e.g., an RRC message), regardless of whether they are activated, or for all serving cells activated (e.g., through a MAC CE), the UE may construct a Type-3 HARQ-ACK codebook based on one or more of the methods described below and may transmit/report the constructed Type-3 HARQ-ACK codebook to the base station.

### (Method 1-1)

When a specific cell among one or more cells indicated by the DCI indicating a Type-3 HARQ-ACK codebook is in an NES-off state, the HARQ-ACK bit(s) for all or requested HARQ process(es) indicated by the DCI for the corresponding cell may not be included in the HARQ-ACK codebook. Accordingly, the UE may construct the HARQ-ACK codebook using only the HARQ-ACK bit(s) corresponding to all or requested HARQ process(es) for the remaining cell(s) excluding the corresponding cell(s).

In this case, when there are no remaining cells other than the corresponding excluded cell(s), the UE may not construct the HARQ-ACK codebook and may not transmit it.

Alternatively, when all cells indicated by the DCI indicating feedback are in an NES-off state, the UE may not construct any HARQ-ACK codebook for all cells and may not transmit the corresponding UCI/PUCCH.

### (Method 1-2)

When a specific cell among one or more cells indicated by the DCI indicating a Type-3 HARQ-ACK codebook is in an NES-off state, the HARQ-ACK bit(s) for all or requested HARQ process(es) indicated by the DCI for the corresponding cell may be indicated as NACK. That is, for the corresponding cell, the UE may construct the HARQ-ACK codebook by indicating the HARQ-ACK bit(s) for all or requested HARQ process(es) indicated by the DCI as NACK.

### Embodiment 2

The present embodiment relates to a method for transmitting and receiving HARQ-ACK information related to a Type-3 HARQ-ACK codebook based on a time period related to NES.

As described above, with respect to the Type-3 HARQ-ACK codebook, the UE may transmit the corresponding PUCCH (i.e., the PUCCH configured/allocated by the base station for transmission of HARQ-ACK information) only during the active time of the second period, or may transmit the corresponding PUCCH only during a separate UL-specific active time or PUCCH-specific active time that is aligned with the active time of the second period. For example, when the UE receives a PDSCH during the active time of the second period, the separate UL-specific active time or PUCCH-specific active time may be set before or after the active time of the second period by a certain offset.

In this regard, when a UL-specific active time or PUCCH-specific active time is configured, the UE may define a time period for the UL-specific active time or the PUCCH-specific active time, and when the UL-specific active time or the PUCCH-specific active time is not configured, the UE may define a time period for the active time of the second period. The UE may transmit a HARQ-ACK for the SPS PDSCH received in the defined time period via the PUCCH or PUSCH. In this case, the UE may transmit the PUCCH or PUSCH only when UL slot(s) or UL symbol(s) of the PUCCH or PUSCH are all included in the defined time period. That is, the UE may be configured/defined to transmit HARQ-ACK information for the SPS PDSCH only when the UL slot(s) or UL symbol(s) of the PUCCH or PUSCH are all included in the defined time period. Alternatively, the UE may be configured/defined to transmit the PUCCH or PUSCH even when only a part of the UL slot(s) or UL symbol(s) of the PUCCH or PUSCH are included in the defined time period.

In relation to the aforementioned operation, when the resource of the PUCCH/PUSCH for transmitting and receiving HARQ-ACK information for the SPS PDSCH is not included in the aforementioned defined time period (e.g., the time period determined/defined such that the operation of the network node/UE is activated), or is only partially included, the UE may transmit or not transmit the HARQ-ACK codebook based on one or more of the following methods, depending on the settings of the network node, etc.

### (Method 2-1)

The UE may operate to transmit the corresponding PUCCH or PUSCH.

For example, when the UE receives an SPS PDSCH transmitted being wholly or partially included in the active time of the second period, even when the PUCCH/PUSCH for transmitting HARQ-ACK information therefor is not included in or is only partially included in the defined time period, the UE may transmit the corresponding PUCCH/PUSCH.

However, when transmission of an SPS PDSCH not wholly or partially included in the active time of the second period occurs (i.e., when transmission of an SPS PDSCH overlapping with an inactive time of the first period occurs), the UE may not transmit the PUCCH/PUSCH for transmitting HARQ-ACK information therefor regardless of whether the UE receives the SPS PDSCH.

In another example, when the UE receives a PDSCH that is entirely or partially included in the active time of the second period, even if the resource of a PUCCH/PUSCH for transmitting HARQ-ACK information therefor is not included or only partially included in the defined time period, the UE may not transmit the PUCCH/PUSCH. Subsequently, when part or all of an alternative PUCCH resource, configured by higher layer signaling (e.g., RRC, etc.) or indicated via DCI by the base station, is included within the defined time period, the UE may transmit HARQ-ACK information for the PDSCH through the alternative PUCCH resource.

In this regard, the alternative PUCCH resource may be set as a PUCCH resource deferred by an offset from the PUCCH slot that could not be transmitted. Here, the value of the offset may be set via higher layer signaling (e.g., RRC, etc.) or indicated via DCI.

Alternatively, the alternative PUCCH resource may be allocated by a DCI indicating the PUCCH resource that could not be transmitted. As one example, the DCI may be defined to indicate not only a K1 value (e.g., a slot offset value) and a PUCCH Resource Indicator (PRI) value for the PUCCH resource that could not be transmitted, but also a K1 value for the alternative PUCCH resource (hereinafter referred to as the alternative K1 value) and a PRI value for the alternative PUCCH resource (hereinafter referred to as the alternative PRI value). Alternatively, information for the alternative K1 value and alternative PRI value may be set via higher layer signaling (e.g., RRC, etc.) or indicated via a DCI instructing cell DRX/DTX-related information. If the base station does not separately configure/indicate the alternative PRI value, the UE may apply the PRI value for the PUCCH resource that could not be transmitted to the alternative PUCCH resource as well.

Alternatively, the base station may allocate an alternative PUCCH resource through a separate DCI. In this case, the separate DCI may be defined to indicate the alternative K1 value and alternative PRI value together. If the base station does not separately configure/indicate the alternative PRI value, the UE may apply the PRI value for the PUCCH resource that could not be transmitted to the alternative PUCCH resource as well. The separate DCI is scrambled with a CRC based on a separate RNTI/C-RNTI/CS-RNTI and may be transmitted and received during the active time of the second period. Further, the separate DCI may schedule a new PDSCH during the active time of the second period, or may be a non-scheduling DCI that does not schedule a PDSCH.

Additionally, the deferred HARQ-ACK information for the alternative PUCCH resource corresponding to the PDSCH may be constructed as a separate Type-3 HARQ-ACK sub-codebook. In this case, when the deferred HARQ-ACK information is multiplexed with new HARQ-ACK information for a PDSCH received after the start of the active time of the second period, the UE may construct the HARQ-ACK codebook by concatenating the separate sub-codebook for the deferred HARQ-ACK information with the sub-codebook for the new HARQ-ACK information.

Additionally, in relation to the above-described method, depending on the configuration (e.g., RRC configuration) or indication (e.g., MAC CE, DCI, etc.) of the network node, even if the PUCCH/PUSCH exists within the defined time period, the UE may exceptionally be configured/defined to transmit the PUCCH/PUSCH.

### (Method 2-2)

The UE may operate to skip the corresponding PUCCH or PUSCH, or may operate not to transmit the corresponding HARQ-ACK information by regarding the HARQ-ACK information as disabled.

### (Method 2-3)

The UE may defer the transmission of the PUCCH or PUSCH until after the active time and operate to transmit the deferred HARQ-ACK information through an alternative PUCCH resource. In this case, the active time may be the above-defined time, that is, the active time of the second period and/or the UL/PUCCH-specific active time.

In this regard, the alternative PUCCH resource may be set as a PUCCH resource deferred by an offset from the PUCCH slot that could not be transmitted. Here, the value of the offset may be set via higher layer signaling (e.g., RRC, etc.) or indicated via DCI.

Alternatively, the alternative PUCCH resource may be allocated by a DCI indicating the PUCCH resource that could not be transmitted. As one example, the DCI may be defined to indicate not only a K1 value (i.e., a slot offset value) and a PUCCH Resource Indicator (PRI) value for the PUCCH resource that could not be transmitted, but also a K1 value for the alternative PUCCH resource (hereinafter referred to as the alternative K1 value) and a PRI value for the alternative PUCCH resource (hereinafter referred to as the alternative PRI value). Alternatively, information for the alternative K1 value and alternative PRI value may be set via higher layer signaling (e.g., RRC, etc.) or indicated via a DCI indicating cell DRX/DTX-related information. If the base station does not separately configure/indicate the alternative PRI value, the UE may apply the PRI value for the PUCCH resource that could not be transmitted to the alternative PUCCH resource as well.

Alternatively, the base station may allocate an alternative PUCCH resource through a separate DCI. In this case, the separate DCI may be defined to indicate the alternative K1 value and alternative PRI value together. If the base station does not separately configure/indicate the alternative PRI value, the UE may apply the PRI value for the PUCCH resource that could not be transmitted to the alternative PUCCH resource as well. The separate DCI is scrambled with a CRC based on a separate RNTI/C-RNTI/CS-RNTI and may be transmitted and received during the active time of the second period. Further, the separate DCI may schedule a new PDSCH during the active time of the second period, or may be a non-scheduling DCI that does not schedule a PDSCH.

Additionally, the deferred HARQ-ACK information for the alternative PUCCH resource corresponding to the PDSCH may be constructed as a separate Type-3 HARQ-ACK sub-codebook. In this case, when the deferred HARQ-ACK information is multiplexed with new HARQ-ACK information for a PDSCH received after the start of the active time of the second period, the UE may construct the HARQ-ACK codebook by concatenating the separate sub-codebook for the deferred HARQ-ACK information with the sub-codebook for the new HARQ-ACK information.

Alternatively, the deferred HARQ-ACK information of the corresponding PDSCH for an alternative PUCCH resource may be constructed as a separate Type-3 HARQ-ACK sub-codebook. In this case, when the active time of the second period starts and the UE receives, through new DCI, a request for the Type-3 HARQ-ACK codebook, the UE may multiplex the newly constructed Type-3 HARQ-ACK sub-codebook and the separate Type-3 sub-codebook for the deferred HARQ-ACK information.

In this case, particularly when the priorities of the two Type-3 HARQ-ACK sub-codebooks are the same, the UE may construct the Type-3 HARQ-ACK codebook by concatenating the separate Type-3 HARQ-ACK sub-codebook for the deferred HARQ-ACK information with the Type-3 HARQ-ACK sub-codebook for the new HARQ-ACK information. Additionally or alternatively, when the priority of the separate Type-3 HARQ-ACK sub-codebook for the deferred HARQ-ACK information is (relatively) higher, the UE may drop the Type-3 HARQ-ACK sub-codebook for the new HARQ-ACK information, construct the Type-3 HARQ-ACK codebook using only the higher-priority separate Type-3 HARQ-ACK sub-codebook, and transmit it to the base station. Additionally or alternatively, when the priority of the Type-3 HARQ-ACK sub-codebook for the new HARQ-ACK information is (relatively) higher, the UE may drop the separate Type-3 HARQ-ACK sub-codebook and construct the Type-3 HARQ-ACK codebook using only the higher-priority new Type-3 HARQ-ACK sub-codebook, and transmit it to the base station.

In this regard, the base station may configure/indicate/designate, through DCI or RRC configuration or the like, the maximum allowable deferral length (i.e., information regarding the maximum time) of the Type-3 HARQ-ACK codebook. Accordingly, if the alternative PUCCH cannot be transmitted within the maximum length after the timing of the DCI indicating the Type-3 HARQ-ACK codebook, or if the alternative PUCCH cannot be transmitted within the maximum length after the PUCCH resource that could not be transmitted, the UE may ignore or cancel the request for the corresponding Type-3 HARQ-ACK codebook. Alternatively, in this case, the UE may discard the Type-3 HARQ-ACK codebook and may not transmit it. Thereafter, the base station may transmit new DCI to request the Type-3 HARQ-ACK codebook from the UE again.

### (Method 1-4)

Since the PUCCH/PUSCH may not be transmitted, the UE may operate to invalidate or skip the corresponding PDSCH.

That is, the UE is unable to transmit HARQ-ACK information for the corresponding PDSCH through the aforementioned PUCCH/PUSCH within the defined time period. Therefore, even when the PDSCH is included in the second period, the UE may not receive the PDSCH, may invalidate the received TB, or may invalidate the PDSCH resource.

Additionally, together with an operation based on one or more of the aforementioned methods, the UE may perform the following exceptional operations.

For example, when DCI received by the UE schedules the transmission of a PDSCH that is not entirely or partially included in the active time of the second period, a case may be considered in which the transmission of a PUCCH/PUSCH for HARQ-ACK information corresponding to the PDSCH is entirely or partially included within the defined time period. In this case, the UE may receive the PDSCH and operate to transmit HARQ-ACK information therefor via the PUCCH/PUSCH. Alternatively, the UE may operate not to receive the PDSCH and not to transmit HARQ-ACK information therefor. Alternatively, the UE may operate not to transmit HARQ-ACK information regardless of whether the PDSCH is received. Alternatively, the UE may operate to transmit NACK information for the PDSCH via the PUCCH/PUSCH regardless of whether the PDSCH is received.

In another example, even when the transmission of a PUCCH/PUSCH for HARQ-ACK information is entirely or partially included within the defined time period, a case may be considered in which the transmission of a PDSCH that is not entirely or partially included in the active time of the second period occurs. In this case, the UE may receive the PDSCH and operate not to transmit HARQ-ACK information therefor via the PUCCH/PUSCH. Alternatively, the UE may operate to transmit NACK information via the PUCCH/PUSCH. Alternatively, the UE may operate not to receive the PDSCH and not to transmit the PUCCH/PUSCH.

In this regard, a scheme of not transmitting HARQ-ACK information in the present disclosure may be based on a scheme of not generating HARQ-ACK for a TB received in the MAC layer. Alternatively, the scheme of not transmitting HARQ-ACK information in the present disclosure may be based on a scheme of not transmitting HARQ-ACK information in the PHY layer even when HARQ-ACK information is generated in the MAC layer. Alternatively, the scheme of not transmitting HARQ-ACK information in the present disclosure may be based on a scheme of invalidating the corresponding HARQ-ACK information or a PUCCH or PUSCH (or UCI of a PUSCH) transmitting the corresponding HARQ-ACK information in the PHY layer even when HARQ-ACK is generated in the MAC layer.

### Embodiment 3

This embodiment relates to a method for constructing and transmitting/receiving a Type-1 HARQ-ACK codebook based on a time period associated with NES.

For the UE in the present disclosure, a Type-1 HARQ-ACK codebook may be configured along with the Type-3 HARQ-ACK codebook in the above-described embodiment.

The Type-1 HARQ-ACK codebook may correspond to a HARQ-ACK codebook semi-statically configured through higher layer signaling (e.g., an RRC message). That is, the Type-1 HARQ-ACK codebook may be referred to as a semi-static based HARQ-ACK codebook.

In relation to the Type-1 HARQ-ACK codebook, the UE may receive/indicated offset information between the DL slot in which the PDSCH is received and the UL slot in which HARQ-ACK information/feedback therefor is reported (e.g., a PDSCH-to-HARQ feedback timing indicator) via DCI. The offset information may be referred to as “K1.” That is, with respect to the Type-1 HARQ-ACK codebook, the UE may construct the HARQ-ACK information for one or more PDSCHs located prior to one or more K1 values based on a specific UL slot as a Type-1 HARQ-ACK codebook, and may transmit the Type-1 HARQ-ACK codebook to the base station in the corresponding UL slot.

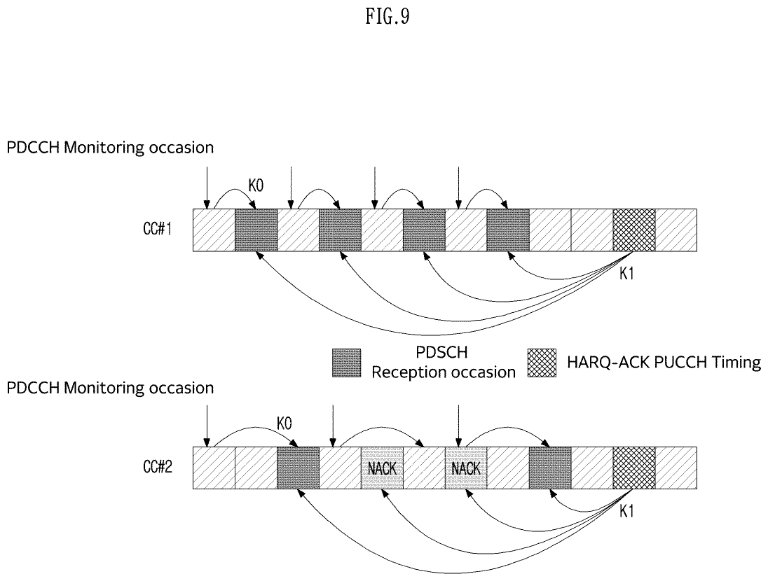

FIG. 9 illustrates a Type-1 HARQ-ACK codebook construction applicable to the present disclosure.

Referring to FIG. 9, when the Type-1 HARQ-ACK codebook configuration method is configured, a UE configured with one or more serving cells may construct a HARQ-ACK codebook to be transmitted in a PUCCH transmission resource slot for each serving cell.

In this case, the HARQ-ACK codebook may be constructed to include, for each HARQ-ACK bit, all PDSCH reception occasions located K1 slots prior to the corresponding PUCCH transmission resource slot.

In relation to the Type-1 HARQ-ACK codebook construction, for clarity of description, a PDSCH reception occasion (i.e., a slot located K1 slots prior based on the slot of the PUCCH resource configured to transmit the HARQ-ACK information) may be referred to as a “K1 slot.”

For example, in a first serving cell (e.g., CC #1), assume that four PDSCHs are transmitted/scheduled to the UE based on four K1 values according to the HARQ-ACK PUCCH timing. That is, based on four different K1 values, four PDSCH reception occasions may be configured/indicated. In this case, the UE receives the PDCCH scheduling each PDSCH at each PDCCH monitoring occasion, and through the DCI received via the PDCCH, obtains information for the slot offset between the PDCCH and the PDSCH (e.g., “K0”). In the case of the first serving cell illustrated in FIG. 9, the K0 value is indicated as 1 (i.e., one slot), based on which the UE may receive the four PDSCHs transmitted from the base station. In this case, the UE constructs four HARQ-ACK bits for the four PDSCHs as a HARQ-ACK codebook and transmits it to the base station in the HARQ-ACK PUCCH timing slot.

In a second serving cell (e.g., CC #2), assume that four PDSCHs are transmitted/scheduled to the UE based on four K1 values according to the HARQ-ACK PUCCH timing. That is, based on four different K1 values, four PDSCH reception occasions may be configured/indicated. In this case, the UE receives the PDCCH scheduling each PDSCH at each PDCCH monitoring occasion, and through the DCI received via the PDCCH, obtains information on the slot offset between the PDCCH and the PDSCH (e.g., “K0”). In the case of the first serving cell illustrated in FIG. 9, the K0 value is indicated as 2 (i.e., two slots), based on which the UE may be able to receive only two of the four PDSCHs transmitted from the base station (e.g., the first and last PDSCHs in the CC #2 case of FIG. 9). In this case, the UE may indicate HARQ-ACK bits as NACK for the two PDSCHs that cannot be received.

In relation to the first period and the second period for the aforementioned NES operation, some or all of the PDSCH reception occasions (i.e., K1 slots) configured/indicated by the base station through certain signaling (e.g., RRC messages, MAC CE, DCI, etc.) may be included in the first period. Alternatively, all or part of the PDSCH reception occasions may not be included in the second period. In the present disclosure, such cases are referred to/determined as PDSCH reception occasions corresponding to NES off.

In this regard, the UE may construct a Type-1 HARQ-ACK codebook based on one or more of the following methods and transmit/report it to the base station.

First, methods applicable when the UE is configured with only one serving cell will be described.

### (Method 3-1-1)

When a specific PDSCH reception occasion(s) located K1 slots prior to the slot of the PUCCH resource for HARQ-ACK transmission is NES off, the UE may not transmit the corresponding PUCCH.

### (Method 3-1-2)

When a specific PDSCH reception occasion(s) located K1 slots prior to the slot of the PUCCH resource for HARQ-ACK transmission is NES off, the UE may indicate the HARQ-ACK bit(s) for the corresponding PDSCH reception occasion(s) as NACK.

### (Method 3-1-3)

When a specific PDSCH reception occasion(s) located K1 slots prior to the slot of the PUCCH resource for HARQ-ACK transmission is NES off, the UE may construct the HARQ-ACK codebook using only the HARQ-ACK bit(s) corresponding to the remaining PDSCH reception occasion(s), excluding the specific PDSCH reception occasion(s).

In this case, if no remaining PDSCH reception occasion exists other than the specific PDSCH reception occasion(s), the UE may not construct the HARQ-ACK codebook and may not transmit it.

Next, when the UE is configured with multiple serving cells, such as in CA, or when multiple serving cells are configured and activated, methods applicable to all serving cells configured through higher layer signaling (e.g., RRC messages, etc.) or to all serving cells activated (e.g., via MAC CE) (regardless of activation status) will be described.

### (Method 3-2-1)

When all PDSCH reception occasions of all cells located K1 slots prior to the slot of the PUCCH resource for HARQ-ACK transmission are NES off, the UE may not transmit the corresponding PUCCH.

### (Method 3-2-2)

When all PDSCH reception occasions of a specific cell(s) located K1 slots prior to the slot of the PUCCH resource for HARQ-ACK transmission are NES off, the UE may construct the HARQ-ACK codebook using only the HARQ-ACK bit(s) corresponding to the PDSCH reception occasion(s) of the remaining cell(s), excluding the specific cell(s).

In this case, if no remaining cell exists other than the specific cell(s), the UE may not construct the HARQ-ACK codebook and may not transmit it.

### (Method 3-2-3)

When a specific PDSCH reception occasion(s) of all cells located K1 slots prior to the slot of the PUCCH resource for HARQ-ACK transmission is NES off, the UE may construct the HARQ-ACK codebook using only the HARQ-ACK bit(s) corresponding to the remaining PDSCH reception occasion(s), excluding the specific PDSCH reception occasion(s), for all cells.

In this case, if no remaining PDSCH reception occasion exists in a particular cell after excluding the specific PDSCH reception occasion(s), the UE may construct the HARQ-ACK codebook using only the HARQ-ACK bit(s) corresponding to the PDSCH reception occasion(s) of the remaining cells, excluding the particular cell. Additionally, if no remaining cell exists after excluding the specific cell(s), the UE may not construct the HARQ-ACK codebook and may not transmit it.

### (Method 3-2-4)

When a specific PDSCH reception occasion(s) of all cells located K1 slots prior to the slot of the PUCCH resource for HARQ-ACK transmission is NES off, the UE may indicate the HARQ-ACK bit(s) for the corresponding PDSCH reception occasion(s) as NACK.

### (Method 3-2-5)

When a specific PDSCH reception occasion(s) located K1 slots prior to the slot of the PUCCH resource for HARQ-ACK transmission is NES off, the UE may construct the HARQ-ACK codebook using only the HARQ-ACK bit(s) corresponding to the remaining PDSCH reception occasion(s) of the cell, excluding the specific PDSCH reception occasion(s).

In this case, if no remaining PDSCH reception occasion exists in the cell after excluding the specific PDSCH reception occasion(s), the UE may construct the HARQ-ACK codebook using only the HARQ-ACK bit(s) corresponding to the PDSCH reception occasion(s) of the remaining cells, excluding the specific cell. Additionally, if no remaining cell exists after excluding the specific cell(s), the UE may not construct the HARQ-ACK codebook and may not transmit it.

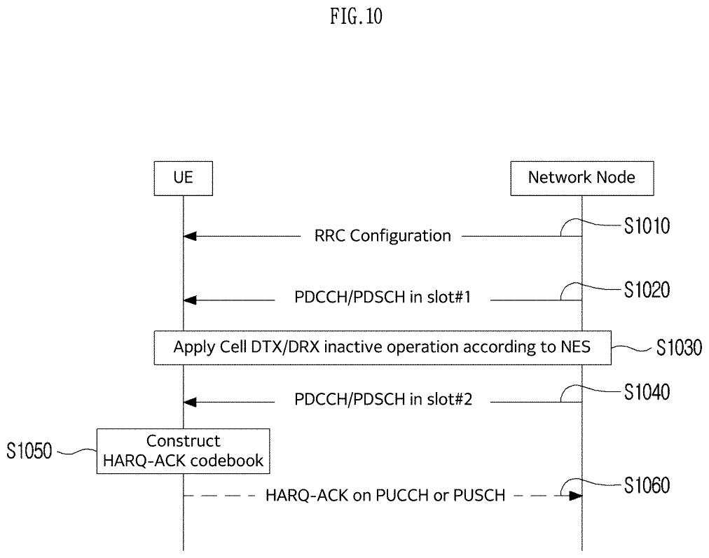

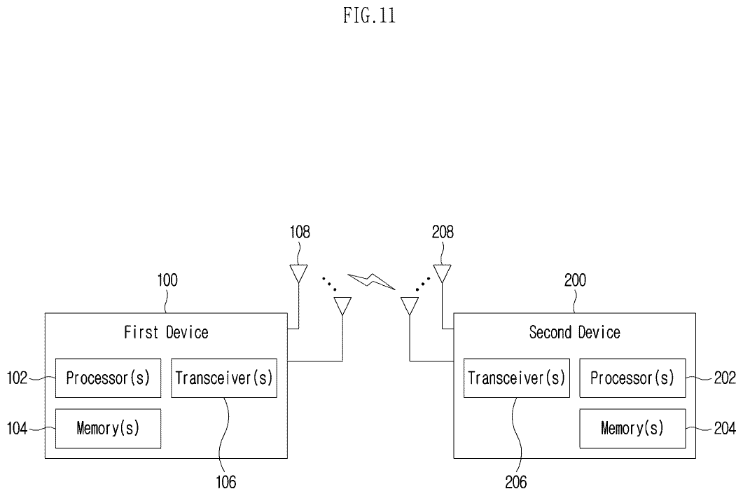

FIG. 10 illustrates an NES-based PDSCH and related HARQ-ACK codebook construction and transmission procedure according to an embodiment of the present disclosure.

Referring to FIG. 10, the network node may transmit to the UE, through an RRC message, configurations related to NES mode, configurations related to SPS PDSCH, and the like (S1010).

Based on the configurations and/or pre-defined information, the network node may transmit PDCCH/PDSCH to the UE in a first slot (e.g., slot #1) (S1020).

Additionally, based on the configurations and/or pre-defined information, NES mode-based inactive operations (e.g., cell DTX/DRX inactive operations) may be applied at the network node and the UE (S1030).

Based on the inactive operations, the network node may transmit PDCCH/PDSCH to the UE in a second slot (for example, slot #2) (S1040).

In this regard, based on the operation(s) described above in the present disclosure, the UE may identify/determine the PDSCH transmission occasion(s) for constructing the HARQ-ACK codebook and construct the HARQ-ACK codebook including the HARQ-ACK bit(s) for the corresponding PDSCH transmission occasion(s) (S1050).

For example, the HARQ-ACK codebook may include a Type-1 HARQ-ACK codebook and/or a Type-3 HARQ-ACK codebook.

When the HARQ-ACK codebook is constructed, the UE may transmit the HARQ-ACK codebook to the network node via PUCCH/PUSCH (S1060). Alternatively, if the UE does not construct the HARQ-ACK codebook, the UE may drop the transmission of the corresponding HARQ-ACK information.

Regarding the construction and transmission of the HARQ-ACK codebook as described in FIG. 10, the detailed method(s) explained/proposed in the embodiment of the present disclosure may be applied.

General Device to which the Present Disclosure May be Applied

FIG. 11 illustrates a block diagram of a wireless communication device according to an embodiment of the present disclosure.

In reference to FIG. 11, a first device 100 and a second device 200 may transmit and receive a wireless signal through a variety of radio access technologies (e.g., LTE, NR).

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a device XXX, YYY of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a device XXX, YYY of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method comprising:
receiving, by a user equipment (UE), information related to inactive and active of cell-related Discontinuous Transmission (DTX) or Discontinuous Reception (DRX);
receiving, by the UE, DCI including information requesting a hybrid automatic repeat request-acknowledgement (HARQ-ACK) codebook;
constructing, by the UE, the HARQ-ACK codebook for at least one serving cell indicated based on the DCI; and
transmitting, by the UE, uplink control information including the HARQ-ACK codebook,
wherein, based on cell-related DTX or DRX being inactive for a specific serving cell among the at least one serving cell, the HARQ-ACK codebook includes HARQ-ACK information for a remaining serving cell excluding the specific serving cell.

2. The method of claim 1, wherein:
based on cell-related DTX or DRX being inactive for a specific serving cell among the at least one serving cell, the HARQ-ACK codebook includes HARQ-ACK information indicated as non-acknowledgement (NACK) for the specific serving cell.

3. The method of claim 1, wherein:
based on absence of the remaining serving cell, the HARQ-ACK codebook is not constructed by the UE.

4. The method of claim 1, wherein:
based on cell-related DTX or DRX being inactive for all of the at least one serving cell, the HARQ-ACK codebook is not constructed by the UE.

5. The method of claim 1, wherein:
the HARQ-ACK codebook is based on a HARQ-ACK codebook type consisting of HARQ-ACK information for the most recent transport block (TB) per HARQ process for the at least one serving cell.

6. The method of claim 1, wherein:
based on a physical uplink control channel (PUCCH) resource for transmitting the uplink control information belonging to an inactive period in which cell-related DTX or DRX is inactive, transmission of the HARQ-ACK codebook is deferred.

7. The method of claim 6, wherein:
based on transmission of the HARQ-ACK codebook being deferred, HARQ-ACK information included in the HARQ-ACK codebook is constructed as a separate HARQ-ACK sub-codebook in an alternative PUCCH resource belonging to an active period in which cell-related DTX or DRX is inactive.

8. The method of claim 7, wherein:
based on existence of a new HARQ-ACK sub-codebook related to the alternative PUCCH resource, the HARQ-ACK codebook to be transmitted in the alternative PUCCH resource is constructed based on a priority between the separate HARQ-ACK sub-codebook and the new HARQ-ACK sub-codebook.

9. The method of claim 8, wherein:
based on a priority of the separate HARQ-ACK sub-codebook being identical to a priority of the new HARQ-ACK sub-codebook, the HARQ-ACK codebook to be transmitted in the alternative PUCCH resource is constructed by concatenating the separate HARQ-ACK sub-codebook to the new HARQ-ACK sub-codebook.

10. The method of claim 8, wherein:
based on a priority of the separate HARQ-ACK sub-codebook being different from a priority of the new HARQ-ACK sub-codebook, the HARQ-ACK codebook to be transmitted in the alternative PUCCH resource is constructed with a HARQ-ACK sub-codebook having a higher priority.

11. The method of claim 6, further comprising:
receiving, through the DCI or higher layer signaling, information for a maximum time allowed for deferral of transmission of the HARQ-ACK codebook.

12. The method of claim 1, wherein:
information related to inactive and active of the cell-related Discontinuous Transmission (DTX) or Discontinuous Reception (DRX) is associated with a network energy saving (NES) mode for one or more cells of a network node.

13. An apparatus for a user equipment (UE), the UE-apparatus comprising:
at least one transceiver for transmitting and receiving a wireless signal; and
at least one processor for controlling the at least one transceiver,
wherein the at least one processor configured to:
receive information related to inactive and active of cell-related Discontinuous Transmission (DTX) or Discontinuous Reception (DRX);
receive DCI including information requesting a hybrid automatic repeat request-acknowledgement (HARQ-ACK) codebook;
construct the HARQ-ACK codebook for at least one serving cell indicated based on the DCI; and
transmit uplink control information including the HARQ-ACK codebook,
wherein, based on cell-related DTX or DRX being inactive for a specific serving cell among the at least one serving cell, the HARQ-ACK codebook includes HARQ-ACK information for a remaining serving cell excluding the specific serving cell.

14. (canceled)

15. An apparatus for a base station, the apparatus comprising:
at least one transceiver for transmitting and receiving a wireless signal; and
at least one processor for controlling the at least one transceiver,
wherein the at least one processor configured to:
transmit information related to inactive and active of cell-related Discontinuous Transmission (DTX) or Discontinuous Reception (DRX);
transmit DCI including information requesting a hybrid automatic repeat request-acknowledgement (HARQ-ACK) codebook; and
receive uplink control information including a HARQ-ACK codebook constructed for at least one serving cell indicated based on the DCI,
wherein, based on cell-related DTX or DRX being inactive for a specific serving cell among the at least one serving cell, the HARQ-ACK codebook includes HARQ-ACK information for a remaining serving cell excluding the specific serving cell.

16. (canceled)

17. (canceled)
